(19) United States
(12) Patent Application Publication
(10) Pub. No.: US 2026/0250513 A1
(43) Pub. Date: Aug. 27, 2026

(54) METHOD FOR MODIFYING SILICA IN THE LIQUID PHASE

(71) Applicant: WACKER CHEMIE AG, München (DE)

(72) Inventor: Elisabeth Leib, Burghausen (DE)

(73) Assignee: WACKER CHEMIE AG, Munich (DE)

(21) Appl. No.: 18/877,329

(22) PCT Filed: Jun. 29, 2022
(86) PCT No.: PCT/EP2022/067966

§ 371 Date: Dec. 20, 2024

(51) Int. Cl. C09C 1/30

(52) U.S. Cl. CPC C09C 1/3081; C01P 2006/12

(57) ABSTRACT

A method for modifying fumed silica. The method includes surface modification of hydrophilic fumed silica having a specific surface area of 10 to 1000 m²/g, in which a suspension of the fumed silica in an organic solvent is reacted with liquid polyorganosiloxane which includes 2 units of the general formula R¹R²R³SiO_{1/2} (M) and 0 to 20 units of the general formula R⁴R⁵Si(O_{1/2})₂(D). Where R¹, R², R³, R⁴ and R⁵ are each a hydroxyl radical or a monovalent hydrocarbon radical having 1 to 24 carbon atoms and at least one radical R¹, R², R³, R⁴, R⁵ and at most 20 mol % based on all radicals R¹, R², R³, R⁴, R⁵ are hydroxyl radicals.

The invention relates to a method for the surface modification of hydrophilic silica with liquid polyorganosiloxane in a suspension of the silica in an organic solvent.

Hydrophobic, surface-modified silicas which have been modified with polydimethylsiloxanes (PDMS) or with chloromethylsilanes are used as thickeners and thixotropic agents in composite materials, coatings and adhesives, particularly in vinyl ester, epoxy and polyurethane systems.

In order to obtain a surface-modified silica, by way of example in accordance with WO2008077814 or EP2824148 a hydrophilic silica is fluidized in the gas phase and functionalized with a PDMS-containing plasticizer. Subsequent heat treatment at 150 to 350° C. is particularly important in order to obtain particularly good bonding of the PDMS chains to the silica surface. This results in very low volatiles contents of less than 0.6% (2 h at 105° C.). However, the material has the disadvantage of very high incorporation times. Since the incorporation of silicas into polymer matrices is the cycle time-determining step in numerous commercial applications, the maximum throughput is strongly linked to the incorporation time.

The invention provides a method for the surface modification of hydrophilic silica having a specific surface area of 10 to 1000 m²/g (measured by the BET method in accordance with DIN EN ISO 9277/DIN 66132), in which a suspension of the silica in an organic solvent is reacted with liquid polyorganosiloxane composed of 2 units of the general formula R¹R²R³SiO_{1/2} (M) and 0 to 20 units of the general formula R⁴R⁵Si(O_{1/2})₂ (D), where R¹, R², R³, R⁴ and R⁵ are each a hydroxyl radical or a monovalent hydrocarbon radical having 1 to 24 carbon atoms, where at least one radical R¹, R², R³, R⁴, R⁵ and at most 20 mol % based on all radicals R¹, R², R³, R⁴, R⁵ are hydroxyl radicals.

The silica modified by the method has consistently good shear thinning in polymer matrices with drastically reduced incorporation times in comparison with conventionally modified silica.

The silica modification is carried out at moderate temperatures in the liquid phase.

The surface of the silica modified by the method has chain-like siloxane structures which have the most homogeneous possible distribution of the chain lengths. These siloxane chains are preferably permanently fixed as completely as possible to the surface of the silica. Furthermore, the siloxane chain is preferably chemically bonded via an individual connection site to the surface of the silica.

The silica used may for example be precipitated silica or fumed silica.

Particular preference is given to fumed silica produced in a flame reaction from organosilicon compounds, for example produced from silicon tetrachloride or methyltrichlorosilane, or hydrotrichlorosilane or hydromethyldichlorosilane, or other methylchlorosilanes or alkylchlorosilanes, including in a mixture with hydrocarbons, or any desired volatilizable or sprayable mixtures of organosilicon compounds, as mentioned, and hydrocarbons, for example in a hydrogen-oxygen flame, or else a carbon monoxide-oxygen flame. The silica may be produced either with or without additional addition of water, for example in the purification step; preference is given to no addition of water.

The silica used preferably has specific surface areas of 40 to 400 m²/g and particularly preferably 150 to 270 m²/g (measured by the BET method in accordance with DIN EN ISO 9277/DIN 66132).

The bulk densities of the silica used (determined in accordance with DIN EN ISO 787-11) may be in the range from 10 to 200 g/1, preferably 20 to 100 g/1, particularly preferably 20 to 60 g/I.

The degree of modification achieved by the method can be analyzed by determining the residual silanol content. The modified silica preferably has a residual silanol content in the range from 30 to 90 mol %, particularly preferably from 45 to 85 mol % and especially preferably from 55 to 75 mol %. A suitable method for determining the residual silanol content after modification by acid-base titration is described for example in G. W. Sears et al. Analytical Chemistry 1956, 28, 1981ff.

The carbon content achieved by the method is preferably 1% by weight to 15% by weight, particularly preferably 2% by weight to 10% by weight, especially preferably from 3% by weight to 8% by weight.

The groups introduced by the modification are firmly bonded to the surface of the silica. A firm bond represents good chemical bonding and is quantified according to the invention by the fraction of modified silica that is extractable with solvents, which is preferably at most 10% by weight. The extractable fraction is particularly preferably at most 6% by weight, in particular at most 4% by weight and specifically preferably at most 2% by weight. A suitable method for evaluating the bonding strength of a modification is the quantitative determination of extractable polyorganosiloxane, i.e. of polyorganosiloxane not chemically bonded to the surface of the modified silica.

Methyl isobutyl ketone MIBK is preferably used for the determination of extractable polyorganosiloxane.

The monovalent hydrocarbon radicals R¹ to R⁵ may be the same or different and are selected from the group of saturated, mono- or polyunsaturated, unbranched or branched hydrocarbon radicals which optionally have heteroatoms and/or functional groups.

Preferably, the hydrocarbon radicals are alkyl, alkenyl and aryl radicals such as methyl, ethyl, propyl, such as n-propyl or i-propyl, butyl, such as n-butyl, i-butyl or t-butyl, hexyl, such as n-hexyl or i-hexyl, octyl, such as n-octyl or i-octyl, dodecyl, tetradecyl, hexadecyl, octadecyl, vinyl, allyl, phenyl, o-tolyl, m-tolyl, p-tolyl, xylyl, mesityl or naphthyl radicals.

The alkyl or aryl radicals may furthermore also have further heteroatoms or functional groups. Preference is given here to monovalent organic groups of the general formula R═(CH₂)ₙY where n=1 to 24 and Y=vinyl, acrylate, methacrylate, glycidoxy, —SH, —OH, primary amine radical (—NH₂), secondary amine radical (—NHR), such as N-monomethyl, N-monoethyl, N-monopropyl, N-monobutyl, N-cyclohexyl or anilino radical, tertiary amine radical (—NR₂) such as N,N-dimethyl, N,N-diethyl, N,N-dipropyl, N,N-dibutyl, N,N-methylethyl, N,N-methylpropyl, N,N-ethylpropyl, N,N-methylphenyl, morpholino, pyrrolyl, indolyl, pyrazoyl, imidazoyl or piperidyl radical, quaternary amine radical such as N,N,N-trimethylammonium, N,N,N-triethylammonium or N,N,N-tripropylammonium radical, phosphonato, —P(O)(OR⁶)₂(R⁷ selected from a methyl, ethyl or phenyl group), isocyanato and protected isocyanato group (—N(H)C(O)G, where the protective group G is eliminated as H-G under thermal stress, where H-G=methyl 2-hydroxybenzoate, 2-hydroxypyridine, 1-hydroxymethyl-1,2,4-triazole, N,N-diethylhydroxylamine, 2-butanone oxime, dimethyl malonate, ethyl acetoacetate, diisopropylamine, benzyl-tert-butylamine, tert-butylmethylamine, tert-butylisopropylamine, 2-isopropylimidazole, 3,5-dimethylpyrazole or Q-caprolactam) or dihydro-3-yl-2,5-furandione.

Furthermore, further organosilicon groups of the general formula R¹¹Si(O_{1/2})₃ may also 20 be present, where the substituent R¹¹ is selected from the hydrocarbon radicals specified above for R.

The monovalent hydrocarbon radicals R¹ to R⁵ are preferably selected from methyl, ethyl, propyl, butyl, and phenyl radicals.

The polyorganosiloxane used in the method preferably has 0 to 15 units, particularly preferably 1 to 10 units, in particular 2 to 10 units of the general formula R⁴R⁵Si(O_{1/2})₂ (D).

The polyorganosiloxane used in the method is liquid preferably in the range from 0 to 60° C., particularly preferably 10 to 50° C., especially preferably from 15 to 30° C. at 0.10 MPa (abs.).

The polyorganosiloxane used in the method has an average viscosity at 20° C. preferably of 5 to 200, particularly preferably 10 to 100, in particular 20 to 60, mPa s.

The polyorganosiloxane may be used in any desired amounts. The amount used is preferably 5% to 50% by weight, particularly preferably 20% to 40% by weight, in particular 15% to 25% by weight, in each case based on the unmodified hydrophilic silica.

In a specific embodiment of the invention, the polyorganosiloxane is used with addition of an auxiliary.

The organic solvent used to produce the suspension of the silica is preferably an aprotic solvent, preferably having a boiling point of at most 120° C., in particular at most 100° C., in each case at 0.10 MPa (abs.), for example a ketone such as acetone, methyl ethyl ketone, an ether such as diethyl ether, dioxane, a hydrocarbon such as pentane, hexane, an aromatic such as toluene or another solvent such as hexamethyldisiloxane. Mixtures may also be used.

Optionally, protic solvents may additionally be added to the method. A solvent is referred to as protic if one molecule has a functional group from which hydrogen atoms in the molecule can be eliminated as protons (dissociation). On account of the high polarity of the OH bond, it can be split comparatively easily with elimination of a positively charged hydrogen atom, the proton.

The most important protic solvent is water, which dissociates (in simplified terms) into a proton and a hydroxide ion. Examples of further protic solvents include alcohols and carboxylic acids. According to the invention, liquid or vaporizable alcohols such as isopropanol, ethanol or methanol or water may for example be added as protic solvent. It is also possible to add mixtures of the abovementioned protic solvents. Preference is given to adding 1% to 50% by weight of protic solvent based on the metal oxide, particularly preferably 5% to 25% by weight. Particular preference is given to the addition of water as protic solvent.

In the surface modification of the hydrophilic silica, it is furthermore possible to use substances which shorten the required reaction times and/or make it possible to reduce the process temperatures. These catalytically or stoichiometrically effective substances are referred to below by the term auxiliaries. They include preferably acidically or basically reacting substances. They may for example be selected from the group of the Lewis acids, which include e.g. trivalent aluminum and boron compounds. Preference is also given to using Brönsted acids, such as hydrogen halides or organic acids. Particular preference is given here to hydrogen chloride or acetic acid. In a further embodiment, used as auxiliary are basically reacting compounds, for example hydroxides of alkali metals and alkaline earth metals, and also their salts derived from the corresponding alcohols or carboxylic acids. In addition, they may be selected from nitrogen-containing compounds such as ammonia or organically substituted primary, secondary or tertiary amines. The monovalent organic substituents of the stated alcohols, carboxylic acids and amines include saturated and unsaturated, branched and unbranched hydrocarbon radicals, which furthermore may also have further heteroatoms or functional groups. The auxiliaries may be added in neat form or else as a solution in inert or reactive solvents.

Preference is given to using aqueous sodium or potassium hydroxide solution, aqueous ammoniacal solution, i-propylamine, n-butylamine, i-butylamine, t-butylamine, cyclohexylamine, triethylamine, morpholine, piperidine or pyridine.

In a preferred embodiment, the amounts of auxiliary used are 0.1% to 10% by weight based on the unmodified silica. Preference is given to using 0.2% to 5% by weight. Particular preference is given here to the use of 0.5% to 1.5% by weight of auxiliary based on the unmodified silica.

The temperature in the surface modification of the hydrophilic silica is preferably in the range from 20 to 140° C., particularly preferably 30 to 120° C., especially preferably from 40 to 100° C. at 0.10 MPa (abs.).

The removal of solvents, excess polyorganosiloxane and byproducts may preferably be effected by means of dryers or by spray drying.

Optionally, the drying step may be followed by a subsequent reaction step in order to complete the reaction.

The subsequent reaction is preferably performed at temperatures of 20-300° C., preferably 20-200° C. and particularly preferably at 40-180° C.

In addition, processes for deagglomeration of the modified silica, such as pin mills, hammer mills, countercurrent mills, impact mills or apparatuses for milling and classifying, may be used after the drying step.

### Analytical Methods:

### Determination of the Carbon Content (% C)

Elemental analysis for carbon was performed in accordance with DIN ISO 10694 using a CS-530 elemental analyzer from Eltra GmbH (D-41469 Neuss).

### Determination of the Residual Content of Unmodified Silica Silanol Groups

The residual silanol content was determined analogously to G. W. Sears et al. Analytical Chemistry 1956, 28, 1981ff by means of acid-base titration of the silica suspended in a 1:1 mixture of water and methanol. The titration was performed in the region above the isoelectric point and below the pH range of dissolution of the silica. The residual silanol content in % can accordingly be calculated according to the following formula:

$$SiOH = SiOH ( silyl ) / SiOH ( phil ) * 100 \%$$

where
SiOH(phil): titration volume from the titration of the untreated silica
SiOH(silyl): titration volume from the titration of the silylated silica
   Determination of the Extractable Fraction, i.e. Of the Fraction of Extractable Polyorganosiloxane

2.5 g of the silica for investigation is stirred with a spatula into 47.5 g of MIBK in a screw-top PE vessel, and the vessel is then closed. After a resting time of 30 min in an ice bath, the mixture is treated for 30 min in an ultrasound bath with ice cooling (Sonorex Digitec DT 156, BANDELIN electronic GmbH & Co. KG, D-12207 Berlin) and then the clear filtrate is obtained by pressure filtration (5 bar of nitrogen) through a PTFE membrane filter (pore size: 0.2 μm, diameter: 47 mm, Sartorius AG, G6ttingen). Exactly 10.00 ml of this filtrate is taken off as analyzate for determining the silicon content by means of atomic absorption spectroscopy (Atom Absorption Spectrometer 2100, Perkin Elmer Waltham, MA, USA) and weighed.

The extractable constituents in % by weight can be calculated to a first approximation as follows:

$$Extractable constituents = {10}^{- 4} \times \frac{m ( MIBK ) \times V ( analyzate )}{m ( metal oxide ) \times M ( Si )} \times \frac{c ( analyzate ) \times M ( {R}^{4} {R}^{5} {SiO}_{2 / 2 )}}{m ( analyzate )}$$

where
m(MIBK): initial weight of MIBK (=47.50 g)
V(analyzate): volume of the analyzate (=10.00 ml)
m(metal oxide): initial weight of the surface-modified metal oxide (=2.50 g)
M(Si): molar mass of silicon (=28.09 g/mol)
c(analyzate): silicon content of the analyzate in mg/I
m(analyzate): final weight of the analyzate in g
M(R⁴R⁵SiO_{2/2}): molecular mass of the D groups R⁴R⁵SiO_{2/2} in g/mol

### Determination of the Viscosity of the Polyorganosiloxane

Determination in accordance with DIN 53019 at 20° C. and 0.10 MPa (abs.)

### EXAMPLES

In the examples which follow, unless stated otherwise in each case, all figures for amounts and percentages are based on weight, all pressures are 0.10 MPa (abs.) and all temperatures are 20° C.

### Example 1: Production of a Highly Hydrophobic Silica in a 2 I Glass Reactor with Subsequent Milling

1140 g of solvent hexamethyldisiloxane was initially charged under argon blanketing into a round 2 I glass reactor equipped with a precision glass stirrer. The reactor was covered with a glass lid having a total of four ground-glass necks and was provided with a reflux condenser with bubble counter and a thermometer immersed in the reactor. A total of 150 g of silica HDK N20 (silica having an initial surface area of 200 m²/g, commercially available from Wacker Chemie AG) was added via a grounded metal funnel using a metal shovel under argon blanketing and a suspension was produced with vigorous stirring with the precision glass stirrer. Finally, 4 g of aqueous ammonia solution (concentration: 5 mol per liter) and 21 g of the plasticizer X345 (mixture of short-chain α-hydroxy-polydimethylsiloxane having an average viscosity of 35 to 50 mPa s) were added to the suspension.

With vigorous stirring, the 2 I glass reactor was immersed as far as possible into an oil bath heated to 120° C. using a magnetic stirrer (Heidolph Instruments MR Hei-Tec magnetic stirrer). The suspension was heated to a temperature of 93° C. and boiled under reflux for two hours. Once the mixture had cooled to room temperature, it was freed of the solvent and any unreacted reactants in a rotary evaporator (Heidolph Instruments) with a vacuum pump and cold trap with an oil bath temperature of 130° C. The dry silica thus obtained was destructured in a fine-milling device (Sugino Dry Burst DB-100S CE, a countercurrent dry mill).

The silica according to the invention had a carbon content of 4.8% by weight. The rheological properties were tested as follows: the modified silica was dispersed in epoxy resin and after one day of storage the viscosity of the mixture was determined at a shear rate of 0.1 s⁻¹ and 10 s⁻¹. The thixotropic index was obtained by dividing the viscosity at low shear rate by the viscosity at high shear rate. The thixotropic index and the incorporation time were determined for two epoxy resin systems:

### Epoxy Resin System 1:

Mixture of 8% by weight of modified silica and 92% by weight of epoxy resin (Epikote™ Resin 828 from Hexion, a commercially available epoxy resin based on bisphenol A and epichlorohydrin).

The silica modified according to the invention had a thixotropic index of 38. The incorporation time of this silica according to the invention was 160 s.

For comparison, use was made of a conventional silica X, not modified according to the invention, composed of HDK@N20 modified with plasticizer X345 in the gas phase having a carbon content of 4.8% by weight.

Silica X had a comparable thixotropic index of 34. The incorporation time of this non-inventive silica was 360 s.

### Epoxy Resin System 2:

Mixture of 8% by weight of modified silica in epoxy resin (Epikote™ Resin 828 from Hexion, a commercially available epoxy resin based on bisphenol A and epichlorohydrin) and 4% by weight of HDK@N20 in amine curing agent (Epikure™ Curing Agent MGSO RIMH-137, commercially available from Hexion), in the mixing ratio of 79% by weight of epoxy resin and 21% by weight of amine curing agent.

Both epoxy resin systems are identical, but in the case of the second system an amine curing agent is added shortly before the measurement. The same incorporation times therefore result in each case for both epoxy resin systems.

The silica modified according to the invention had a thixotropic index of 54.

### Example 2: Production of a Highly Hydrophobic Silica in a 2 I Three-Necked Flask with Subsequent Heat Treatment

855 g of solvent hexamethyldisiloxane was initially charged under argon blanketing into a 2 I three-necked glass flask equipped with a precision glass stirrer. The reactor was provided with a reflux condenser with bubble counter and a thermometer. A total of 112 g of silica HDK@N20 was added via a grounded metal funnel using a metal shovel under argon blanketing and a suspension was produced with vigorous stirring with the precision glass stirrer. Finally, 3 g of aqueous ammonia solution (concentration: 5 mol per liter) and 16 g of the plasticizer X345 were added to the suspension.

With vigorous stirring, the three-necked flask was provided with a heating mantle (Pilz® heating mantle from Carlroth). The suspension was heated to a temperature of 50° C. and kept at this temperature for two hours with strong stirring. Once the mixture had cooled to room temperature, it was freed of the solvent and any unreacted reactants in a rotary evaporator (Heidolph Instruments) with a vacuum pump and cold trap with an oil bath temperature of 130° C.

The silica thus obtained was then heat-treated at 200° C. for an hour in a drying cabinet with nitrogen purging. The final silica according to the invention had a carbon fraction of 4.8% by weight.

### Epoxy Resin System 1:

The silica modified according to the invention had a thixotropic index of 36. The incorporation time of this silica according to the invention was 9 s.

Silica X had a comparable thixotropic index of 34. The incorporation time of this non-inventive silica was 186 s.

### Epoxy Resin System 2:

The silica modified according to the invention had a thixotropic index of 56.

Silica X had a comparable thixotropic index of 60.

1-7. (canceled)

8. A method for modifying fumed silica, comprising:
modifying a surface of hydrophilic fumed silica having a specific surface area of 10 to 1000 m²/g (measured by the BET method in accordance with DIN EN ISO 9277/DIN 66132), in which a suspension of the silica in an organic solvent is reacted with liquid polyorganosiloxane which comprises 2 units of the general formula R¹R²R³SiO_{1/2} (M) and 0 to 20 units of the general formula R⁴R⁵Si(O_{1/2})₂ (D);
wherein R¹, R², R³, R⁴ and R⁵ are each a hydroxyl radical or a monovalent hydrocarbon radical having 1 to 24 carbon atoms; and
wherein at least one radical R¹, R², R³, R⁴, R⁵ and at most 20 mol % based on all radicals R¹, R², R³, R⁴, R⁵ are hydroxyl radicals.

9. The method of claim 8, wherein the carbon content achieved by the method is 1% by weight to 15% by weight.

10. The method of claim 8, wherein the monovalent hydrocarbon radicals R¹ to R⁵ are selected from methyl, ethyl, propyl, butyl, and phenyl radicals.

11. The method of claim 8, wherein the polyorganosiloxane is liquid in the range from 0 to 60° C. at 0.10 MPa (abs.).

12. The method of claim 8, wherein the organic solvent used to produce the suspension of the silica is an aprotic solvent.

13. The method of claim 12, wherein a protic solvent is additionally added.
